(19) United States
(12) Patent Application Publication
(10) Pub. No.: US 2026/0184397 A1
(43) Pub. Date: Jul. 2, 2026

(54) FOLDING SEAT STRUCTURE AND FOLDING SCOOTER

(71) Applicant: Zhejiang Mateside Medical Devices Technology Co., Ltd., Hangzhou (CN)

(72) Inventors: Zhikuo Liu, Hangzhou (CN); Tengxuan Zhang, Hangzhou (CN); Yongliang Hu, Hangzhou (CN); Shikun Tian, Hangzhou (CN); Rui Wang, Hangzhou (CN); Tingyu Lou, Hangzhou (CN); Juntao Li, Hangzhou (CN); Haonan Lan, Hangzhou (CN); Rui Gao, Hangzhou (CN); Ming Lu, Hangzhou (CN); Tao Sun, Hangzhou (CN); Jiajia Wang, Hangzhou (CN); Wenhao Zhang, Hangzhou (CN)

(21) Appl. No.: 19/435,823

(22) Filed: Dec. 30, 2025

(30) Foreign Application Priority Data
Dec. 31, 2024 (CN) 202411998090.8

(51) Int. Cl. B62J 1/08; B62J 1/12; B62J 1/28; B62K 5/025; B62K 15/00; B62K 21/12

(52) U.S. Cl. CPC B62J 1/08; B62J 1/12; B62J 1/28; B62K 5/025; B62K 15/00; B62K 21/12; B62K 2015/005; B62K 2202/00

(57) ABSTRACT

The present disclosure provides a folding seat structure and a folding scooter. The folding seat structure includes a backrest mechanism, an armrest mechanism and a folding mechanism. The armrest mechanism includes an armrest assembly, an armrest elevating assembly, an armrest rotating assembly and an armrest moving assembly. The seat assembly is arranged at a top end of the folding mechanism. A bottom of the folding mechanism is hinged to a vehicle frame and is capable of being switched between an unfolded position and a folded position relative to the vehicle frame.

### CROSS-REFERENCE TO RELATED APPLICATIONS

The present disclosure claims the priority to the Chinese patent application with the filing No. 202411998090.8 filed with the China National Intellectual Property Administration on Dec. 31, 2024, and entitled “FOLDING SEAT STRUCTURE AND FOLDING SCOOTER”, which is incorporated herein by reference in entirety.

### TECHNICAL FIELD

The present disclosure relates to the technical field of scooters, in particular to a folding seat structure and a folding scooter.

### BACKGROUND

At present, seat structures of scooters on the market usually only have an elevating adjustment function, which cannot satisfy the comfortable use of all people. Moreover, the seat structure does not have a folding function and occupies a large space, making it difficult for users to conveniently carry it into public transportation facilities or manually transfer it over a short distance. This is particularly prominent when it is necessary to flexibly switch travel modes or face natural obstacles such as stairs and steps, which greatly limits its convenience of use. However, existing folding mechanisms that can fold the seat and the vehicle frame together are usually arranged on both sides of the vehicle frame, resulting in space occupation on both sides of the vehicle, limiting the activity space of the user, and reducing the convenience of the folding operation. In addition, since the armrests on the seat structure are fixed and cannot be folded, they hinder the user from boarding/alighting, and are likely to cause the user to bump.

### SUMMARY

The present disclosure provides a folding seat structure and a folding scooter to at least solve the above technical problems existing in the prior art.

A folding seat structure is provided, including a seat assembly, and further including:
a backrest mechanism, rotatably connected to the seat assembly and capable of being folded relative to the seat assembly;
an armrest mechanism, including an armrest assembly, an armrest elevating assembly, an armrest rotating assembly, and an armrest moving assembly, wherein the armrest moving assembly is fixedly connected to a lower surface of the seat assembly and is arranged along a width direction of the seat assembly; the armrest rotating assembly is slidably connected to the armrest moving assembly and is capable of sliding along a length direction of the armrest moving assembly; one end of the armrest elevating assembly is rotatably connected to the armrest rotating assembly; and the armrest assembly is arranged on the other end of the armrest elevating assembly; and
a folding mechanism, wherein the seat assembly is arranged at a top end of the folding mechanism, and a bottom of the folding mechanism is hinged at a central position in a width direction of a vehicle frame and is capable of being switched between an unfolded position and a folded position relative to the vehicle frame.

A folding scooter is provided. The folding scooter includes a vehicle frame, a driving wheel set, a steering wheel set and an auxiliary moving wheel set, and further includes a handlebar mechanism and the folding seat structure described in any one of the foregoing embodiments. The handlebar mechanism includes a connecting component fixed at a front end of the vehicle frame and a handlebar component rotatably connected to the connecting component, and when the entire folding seat structure is in a folded state, the handlebar component is folded over the folding seat structure relative to the connecting component.

It should be understood that the foregoing description is not intended to designate key or important features of the embodiments of the present disclosure, nor to limit the scope of the present disclosure. Other features of the present disclosure will be made easier to understand through the following specification.

### BRIEF DESCRIPTION OF DRAWINGS

By reading the following detailed description with reference to the drawings, the above and other objects, features and advantages of exemplary embodiments of the present disclosure will be made easier to understand. In the drawings, several embodiments of the present disclosure are shown in an exemplary rather than limiting manner.

In the drawings, the same or corresponding reference numerals indicate the same or corresponding parts.

FIG. 1 shows a first schematic diagram of an overall structure of a folding seat structure according to an exemplary embodiment of the present disclosure;

FIG. 2 shows a second schematic diagram of an overall structure of a folding seat structure according to an exemplary embodiment of the present disclosure;

FIG. 3 shows a first schematic diagram of an overall folded structure of a folding seat structure according to an exemplary embodiment of the present disclosure;

FIG. 4 shows a second schematic diagram of an overall folded structure of a folding seat structure according to an exemplary embodiment of the present disclosure;

FIG. 5 shows a schematic structural diagram of a backrest mechanism of a folding seat structure according to an exemplary embodiment of the present disclosure;

FIG. 6 shows a first schematic structural diagram of a seat adjusting mechanism of a folding seat structure according to an exemplary embodiment of the present disclosure;

FIG. 7 shows a second schematic structural diagram of a seat adjusting mechanism of a folding seat structure according to an exemplary embodiment of the present disclosure;

FIG. 8 shows a third schematic structural diagram of a seat adjusting mechanism of a folding seat structure according to an exemplary embodiment of the present disclosure;

FIG. 9 shows a schematic structural diagram of an armrest mechanism of a folding seat structure according to an exemplary embodiment of the present disclosure;

FIG. 10 shows a first partial enlarged view of an armrest mechanism of a folding seat structure according to an exemplary embodiment of the present disclosure;

FIG. 11 shows a second partial enlarged view of an armrest mechanism of a folding seat structure according to an exemplary embodiment of the present disclosure;

FIG. 12 shows a schematic structural diagram of a folding mechanism of a folding seat structure according to an exemplary embodiment of the present disclosure;

FIG. 13 shows a first schematic diagram of an overall folded structure of a folding scooter according to an exemplary embodiment of the present disclosure;

FIG. 14 shows a second schematic diagram of an overall folded structure of a folding scooter according to an exemplary embodiment of the present disclosure; and

FIG. 15 shows a schematic structural diagram of a handlebar mechanism of a folding scooter according to an exemplary embodiment of the present disclosure.

Description of reference numerals: 1, seat assembly; 2, backrest mechanism; 3, armrest mechanism; 4, folding mechanism; 5, seat adjusting mechanism; 6, handlebar mechanism; 7, vehicle frame; 8, driving wheel set; 9, steering wheel set; 10, auxiliary moving wheel set; 21, backrest bracket; 22, backrest component; 31, armrest assembly; 32, armrest elevating assembly; 33, armrest rotating assembly; 34, armrest moving assembly; 41, front arm; 42, rear arm; 43, seat bracket; 44, sliding component; 51, base; 52, seat moving assembly; 53, seat rotating assembly; 61, connecting component; 62, handlebar component; 63, folding assembly; 321, elevating adjustment part; 322, strut; 331, rotating shaft part; 332, rotation control part; 341, hollow sleeve; 342, locking part; 411, groove; 431, sliding chute; 521, mounting seat; 522, moving adjustment part; 523, first seat support; 524, first locking assembly; 531, turntable; 532, elastic member; 533, rotation adjusting part; 534, second seat support; 535, limiting assembly; 536, second locking assembly; 631, first folding piece; 632, second folding piece; 633, locking piece; 3221, bearing portion; 3222, accommodating groove; 3223, stop portion; 3311, guide portion; 5211, detent; 5212, second positioning hole; 5221, locking pin shaft; 5222, adjustment fixing portion; 5223, positioning block; 5331, positioning portion; 5332, hand-held portion; 5341, first limiting hole; 5351, second limiting hole.

### DETAILED DESCRIPTION OF EMBODIMENTS

To make the objectives, features and advantages of the present disclosure more obvious and easier to understand, the technical solutions in the embodiments of the present disclosure will be described clearly and completely below with reference to the drawings in the embodiments of the present disclosure. Obviously, the described embodiments are only part of the embodiments of the present disclosure, not all of them. Based on the embodiments of the present disclosure, all other embodiments obtained by those skilled in the art without creative effort shall fall within the scope of protection of the present disclosure.

According to a first aspect of the present disclosure, a folding seat structure is provided, including a seat assembly, and further including:
a backrest mechanism, rotatably connected to the seat assembly and capable of being folded relative to the seat assembly;
an armrest mechanism, including an armrest assembly, an armrest elevating assembly, an armrest rotating assembly, and an armrest moving assembly, wherein the armrest moving assembly is fixedly connected to a lower surface of the seat assembly and is arranged along a width direction of the seat assembly; the armrest rotating assembly is slidably connected to the armrest moving assembly and is capable of sliding along a length direction of the armrest moving assembly; one end of the armrest elevating assembly is rotatably connected to the armrest rotating assembly; and the armrest assembly is arranged on the other end of the armrest elevating assembly; and
a folding mechanism, wherein the seat assembly is arranged at a top end of the folding mechanism, and a bottom of the folding mechanism is hinged at a central position in a width direction of a vehicle frame and is capable of being switched between an unfolded position and a folded position relative to the vehicle frame.

In an embodiment, the folding seat structure further includes a seat adjusting mechanism arranged between the seat assembly and the folding mechanism, wherein the seat adjusting mechanism includes a base and a seat moving assembly connected to the seat assembly, the base is fixedly connected to the top end of the folding mechanism, and the seat moving assembly is slidably connected to the base.

In an embodiment, the folding seat structure further includes a seat adjusting mechanism arranged between the seat assembly and the folding mechanism, wherein the seat adjusting mechanism includes a seat rotating assembly for carrying the seat assembly, and the seat rotating assembly is rotatably connected to the folding mechanism to drive the seat assembly to rotate relative to the folding mechanism.

In an embodiment, the seat rotating assembly includes a turntable, an elastic member and a rotation adjusting part connected to the elastic member, the elastic member is fixedly connected to a lower surface of the turntable, and the rotation adjusting part is configured to position the elastic member on a path rotating about a rotating shaft of the turntable; and
the rotation adjusting part has a locked state and an unlocked state; when the rotation adjusting part is in the locked state, the elastic member is engaged with and limited by the rotation adjusting part; and when an external force is applied to the rotation adjusting part, the rotation adjusting part is switched to the unlocked state, such that the turntable and the elastic member are capable of rotating synchronously and freely.

In an embodiment, the armrest rotating assembly includes a rotating shaft part and a rotation control part, one end of the armrest elevating assembly away from the armrest assembly is sleeved on the rotating shaft part, and the armrest elevating assembly is capable of rotating about an axis of the rotating shaft part, and the rotating shaft part and the armrest elevating assembly are connected via the rotation control part; and
the rotation control part has an initial position and a terminal position in a length direction of the rotating shaft part; when the rotation control part is at the terminal position, the armrest elevating assembly is capable of rotating freely about the rotating shaft part; and when the armrest elevating assembly rotates to a specific position, the rotation control part rebounds from the terminal position to the initial position to restrict rotation of the armrest elevating assembly.

In an embodiment, the armrest elevating assembly includes an elevating adjustment part and a strut, the armrest assembly is connected to the elevating adjustment part, and the elevating adjustment part is sleeved on the strut to drive the armrest assembly to move along a length direction of the strut; the armrest moving assembly includes a hollow sleeve fixed on the lower surface of the seat assembly, and the armrest rotating assembly is inserted into the hollow sleeve to drive the two armrest assemblies to move towards or away from each other along the width direction of the seat assembly.

In an embodiment, the folding mechanism includes a front arm, a rear arm and a seat bracket, the seat assembly and the seat bracket are fixedly connected, a top end of the front arm is hinged to a front end of the seat bracket, a bottom end of the front arm is hinged to the vehicle frame, a top end of the rear arm is hinged to a rear end of the seat bracket, and a bottom end of the rear arm is hinged to the vehicle frame.

In an embodiment, the folding mechanism further includes a sliding component, the seat bracket is provided with a sliding chute, the sliding component is slidably connected to the sliding chute, the front arm is provided with a groove, and when the sliding component slides into the groove along the sliding chute, the seat bracket, the front arm and the rear arm are fixed.

According to a second aspect of the present disclosure, a folding scooter is provided, including a vehicle frame, a driving wheel set, a steering wheel set and an auxiliary moving wheel set, and further including a handlebar mechanism and the folding seat structure described in any one of the foregoing embodiments, wherein the handlebar mechanism includes a connecting component fixed at a front end of the vehicle frame and a handlebar component rotatably connected to the connecting component, and when the entire folding seat structure is in a folded state, the handlebar component is folded over the folding seat structure relative to the connecting component.

In an embodiment, the handlebar mechanism further includes a folding assembly, the folding assembly includes a first folding piece connected to the connecting component and a second folding piece connected to the handlebar component, the first folding piece and the second folding piece are rotatably connected, a locking piece is arranged between the first folding piece and the second folding piece, and the locking piece is coaxially arranged with the first folding piece and is capable of rotating relative to the first folding piece about a common axis.

According to the folding seat structure and folding scooter of the present disclosure, through the design of the backrest mechanism, the armrest mechanism and the folding mechanism, the folding seat structure allows the backrest mechanism to be stowed towards the seat assembly after use, being folded into a relatively flat shape. The folding mechanism can lower and stow the overall structure of the seat, enabling the scooter to be significantly reduced in size when not in use, facilitating easy carrying, transporting and storage by the user. Moreover, the folding mechanism is arranged at the central position in the width direction of the vehicle frame, making the folding and unfolding of the entire seat smoother, while reducing the occupation of space on both sides of the vehicle and eliminating restrictions on the activity space of the user. In addition, the armrest mechanism integrates the elevating function, rotating function and moving function. When the user is not using the vehicle, not only can the height of the armrest assembly be lowered and the distance between the two armrest assemblies be reduced towards the interior of the scooter to decrease the space occupied by the armrest mechanism, but the armrest rotating assembly can also be combined to drive the armrest assembly to rotate, allowing it to be stowed into a smaller size.

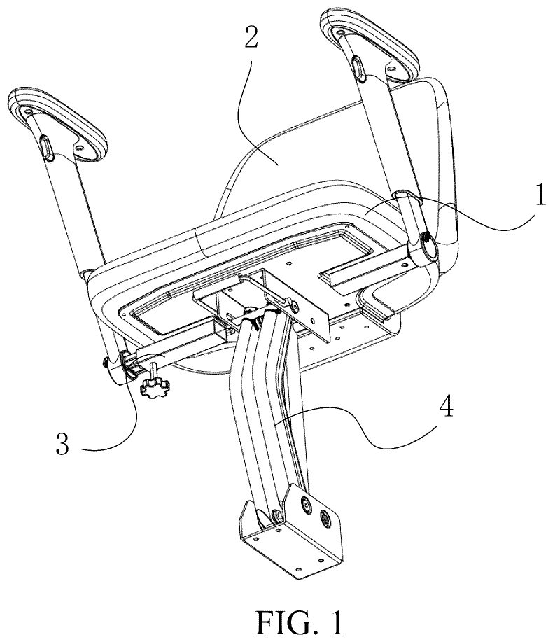

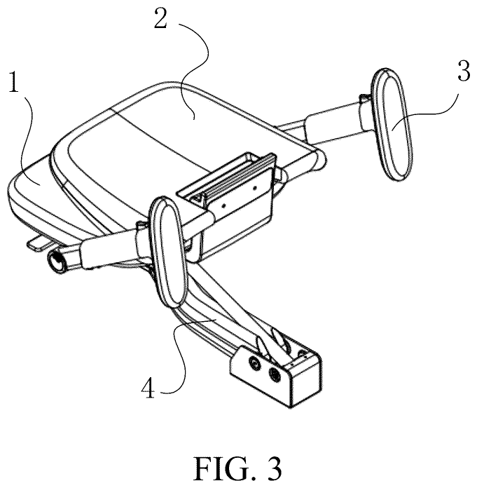

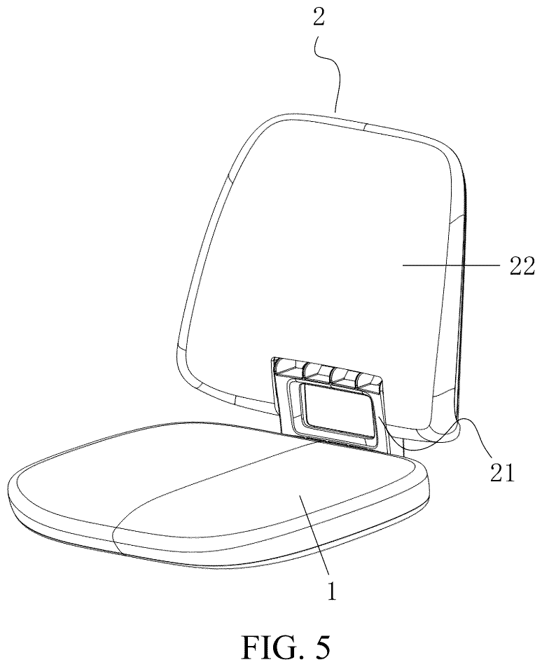

Referring to FIGS. 1, 3, 5 and 9, a folding seat structure according to an exemplary embodiment of the present disclosure includes a seat assembly 1, a backrest mechanism 2, an armrest mechanism 3 and a folding mechanism 4. The seat assembly 1 provides a seat for a user. The backrest mechanism 2 is rotatably connected to the seat assembly 1 and can be folded relative to the seat assembly 1. The armrest mechanism 3 includes an armrest assembly 31, an armrest elevating assembly 32, an armrest rotating assembly 33 and an armrest moving assembly 34. The armrest moving assembly 34 is fixedly connected to a lower surface of the seat assembly 1 and is arranged along a width direction of the seat assembly 1. The armrest rotating assembly 33 is slidably connected to the armrest moving assembly 34 and can slide along a length direction of the armrest moving assembly 34. One end of the armrest elevating assembly 32 is rotatably connected to the armrest rotating assembly 33, and the armrest assembly 31 is arranged on the other end of the armrest elevating assembly 32. The seat assembly 1 is arranged at a top end of the folding mechanism 4. A bottom of the folding mechanism 4 is hinged at a central position in a width direction of a vehicle frame and can be switched between an unfolded position and a folded position relative to the vehicle frame.

In this embodiment, first, it should be noted that the front, rear, left, right, up and down directions in the present disclosure are based on the directions when the folding seat structure is in normal use. For example, the seat assembly 1 is arranged in front of the backrest mechanism 2 to provide a seat for the user. The backrest mechanism 2 provides back support for the user. The design of the backrest mechanism 2 typically considers ergonomics to ensure comfort and safety of the user during use. The width direction of the seat assembly 1 or the vehicle frame is the left-right direction. The backrest mechanism 2 includes a backrest bracket 21 and a backrest component 22. The backrest bracket 21 has a support portion. The backrest component 22 can be supported by the support portion to prevent the backrest component 22 from folding backward, thereby enhancing the stability of the overall mechanism. One end of the backrest bracket 21 away from the support portion is fixedly connected to the seat assembly 1. The backrest component 22 is rotatably connected to the backrest bracket 21 and can rotate relative to the backrest bracket 21 about a rotation center. The armrest mechanism 3 integrates the elevating function, rotating function and moving function. It enables the armrest assembly 31 to be lowered in the height direction and the distance between the two armrest assemblies 31 to be shortened in the width direction when the user is not using the folding seat structure, thereby reducing the space occupied by the armrest mechanism 3. It also enables the armrest assembly 31 to be flipped to avoid the boarding/alighting position, which not only facilitates the user boarding/alighting, but also allows the armrest mechanism 3 to be stowed into a more compact form, facilitating carrying and transportation while saving storage space. When using the folding seat structure, the user can adjust the position of the armrest assembly 31 in the width direction and height direction of the seat assembly 1 according to their own size, providing strong adaptability. The armrest moving assembly 34 is fixedly connected to the lower surface of the seat assembly 1 and is arranged along the width direction of the seat assembly 1 to ensure that the armrest rotating assembly 33 can drive the armrest assemblies 31 to move along the width direction, thereby adjusting the distance between the two armrest assemblies 31. A damping control structure or a mechanical control structure can be provided at the rotational connection between the armrest elevating assembly 32 and the armrest rotating assembly 33, wherein the damping control structure or the mechanical control structure is configured to lock the armrest elevating assembly 32, after being rotated about the armrest rotating assembly 33, at a specific position. For example, when the damping control structure is provided, a damper can be directly mounted on the rotating shaft to produce a damping effect through friction. When the mechanical control structure is provided, specific mechanical structures are designed to limit or adjust the rotational position. Common mechanical control methods include, but are not limited to, key connections, pin connections, or threaded connections. For the folding mechanism 4, when the seat assembly 1 needs to be used, the folding mechanism 4 drives the seat assembly 1 to elevate as a whole, bringing the seat assembly 1 to a normal use height. At this time, the folding mechanism 4 is in the unfolded position. When the seat assembly 1 needs to be stowed, the folding mechanism 4 is flipped towards the front end of the vehicle frame to drive the seat assembly 1 to be lowered as a whole until it engages with the vehicle frame. At this time, the folding mechanism 4 is in the folded position. A damping control structure or a mechanical control structure can be provided at both the connection between the seat assembly 1 and the top end of the folding mechanism 4, and at the hinge between the bottom of the folding mechanism 4 and the vehicle frame, wherein the damping control structure or a mechanical control structure is configured to lock the folding mechanism 4, after being rotated about the vehicle frame, at a specific position. It should be noted that when a damping control structure is selected, the design should be based on ensuring the stability and safety of the seat assembly 1 during normal use by the user, such that the folding mechanism 4 can be folded and unfolded. Since the folding mechanism 4 is arranged at the central position in the width direction of the vehicle frame, the folding and unfolding of the entire seat is smoother, while reducing the occupation of space on both sides of the vehicle and eliminating restrictions on the activity space of the user, facilitating the user boarding/alighting and preventing leg bumps. It can be understood that preferably, the folding mechanism 4 is flipped towards the front end of the vehicle frame to drive the seat assembly 1 to be lowered as a whole, and the armrest elevating assembly 32 drives the armrest assembly 31 to flip backward, thereby achieving optimal space utilization after folding. In summary, the folding seat structure of the present disclosure, through the design of the backrest mechanism 2, the armrest mechanism 3 and the folding mechanism 4, allows the backrest mechanism 2 to be stowed towards the seat assembly 1 after use, being folded into a relatively flat shape. The folding mechanism 4 can lower and stow the overall structure of the seat, enabling the scooter to be significantly reduced in size when not in use, facilitating easy carrying, transporting and storage by the user. Moreover, the folding mechanism 4 is arranged at the central position in the width direction of the vehicle frame, making the folding and unfolding of the entire seat smoother, while reducing the occupation of space on both sides of the vehicle and eliminating restrictions on the activity space of the user. In addition, the armrest mechanism 3 integrates the elevating function, rotating function and moving function. When the user is not using the vehicle, not only can the height of the armrest assembly 31 be lowered and the distance between the two armrest assemblies 31 be reduced towards the inside of the scooter to decrease the space occupied by the armrest mechanism 3, but the armrest rotating assembly 33 can also be combined to drive the armrest assembly 31 to rotate, allowing it to be stowed into a smaller size.

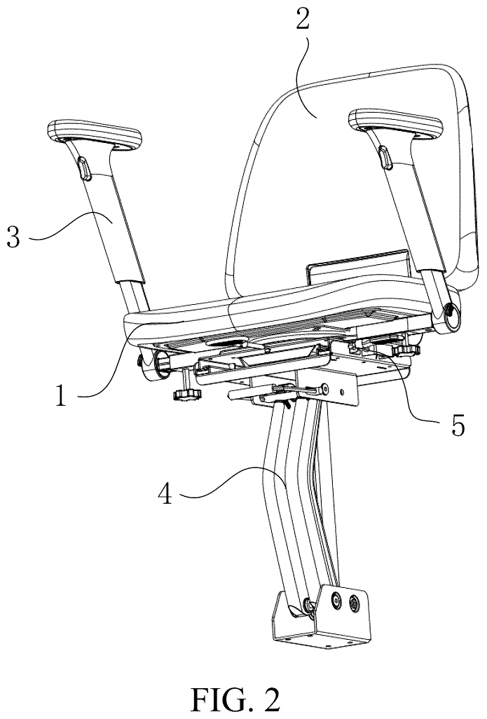

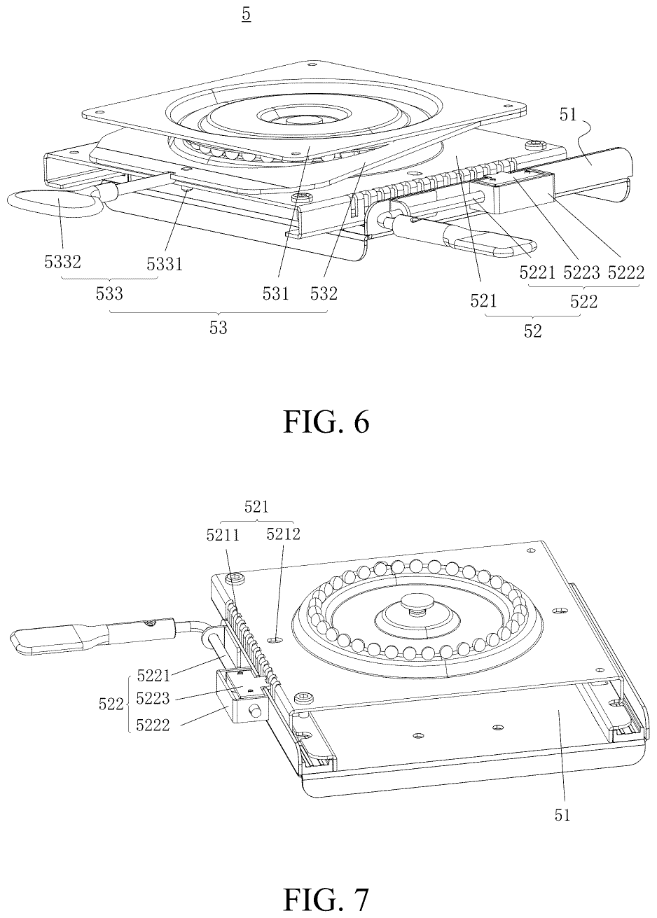

Referring to FIGS. 2, 4, 6 and 7, in an embodiment, the folding seat structure further includes a seat adjusting mechanism 5 arranged between the seat assembly 1 and the folding mechanism 4. The seat adjusting mechanism 5 includes a base 51 and a seat moving assembly 52 connected to the seat assembly 1. The base 51 is fixedly connected to the top end of the folding mechanism 4, and the seat moving assembly 52 is slidably connected to the base 51.

In this embodiment, the seat moving assembly 52 includes a mounting seat 521 and a moving adjustment part 522. The seat assembly 1 is fixedly connected to the mounting seat 521. A slide rail is provided on the base 51. The mounting seat 521 is slidably connected to the base 51 via the slide rail to drive the seat assembly 1 to slide relative to the base 51. When the folding mechanism 4 is in the unfolded position, the mounting seat 521 is controlled to move along the slide rail to adjust the space in front of the seat assembly 1, thereby adapting to people of different sizes. When the folding mechanism 4 needs to be switched to the folded position, the mounting seat 521 is controlled to move forward along the slide rail, such that after the armrest elevating assembly 32 drives the armrest assembly 31 to flip backward, interference between the armrest assembly 31 and other components on the scooter is avoided, ensuring the folding effect. The moving adjustment part 522 is arranged on the base 51 and can lock and unlock the mounting seat 521. It can be understood that the moving adjustment part 522 can have various structures to choose from. For example, the moving adjustment part 522 includes a locking pin shaft 5221 rotatable about a rotation center and an adjustment fixing portion 5222 provided on the base 51. The locking pin shaft 5221 is disposed through the adjustment fixing portion 5222. A positioning block 5223 is fixedly connected on the locking pin shaft 5221 and is located within the adjustment fixing portion 5222. Correspondingly, a plurality of detents 5211 are provided along the moving direction of the mounting seat 521 on the side of the mounting seat 521. The positioning block 5223 can engage with the detent 5211. The moving adjustment assembly further includes a torsion spring sleeved on the locking pin shaft 5221 and connected to the adjustment fixing portion 5222. The torsion spring serves a reset function. When the torsion spring is in its initial state, the positioning block 5223 engages with the detent 5211. If it is necessary to unlock the mounting seat 521 to allow it to move along the slide rail, the locking pin shaft 5221 needs to be rotated to cause the positioning block 5223 to rotate in a direction away from the detent 5211, releasing the limitation on the mounting seat 521. At this time, the torsion spring elastically deforms. After the mounting seat 521 is adjusted to the desired position, the external force is removed, and the torsion spring resets, causing the positioning block 5223 to engage with the detent 5211.

In an embodiment, the folding seat structure further includes a seat adjusting mechanism 5 arranged between the seat assembly 1 and the folding mechanism 4. The seat adjusting mechanism 5 includes a seat rotating assembly 53 for carrying the seat assembly 1. The seat rotating assembly 53 is rotatably connected to the folding mechanism 4 to drive the seat assembly 1 to rotate relative to the folding mechanism 4.

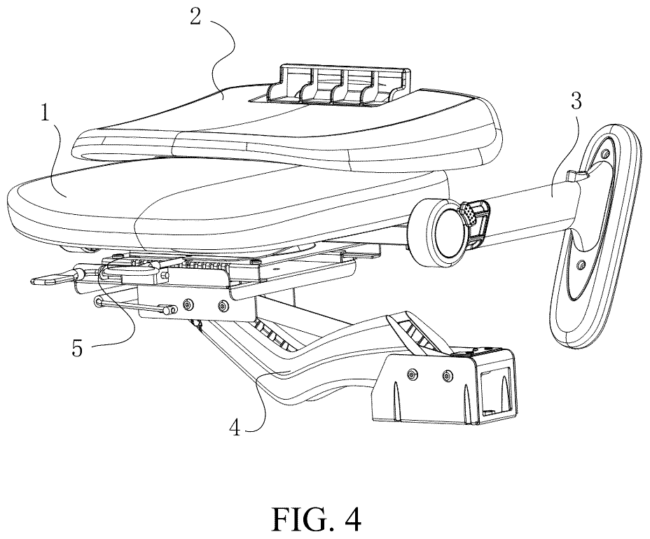

In this embodiment, there are two ways to arrange the seat rotating assembly 53. One is to directly rotatably connect the seat rotating assembly 53 with the top end of the folding mechanism 4 (not shown in the figures), such that the seat assembly 1 only has a rotating function. The other is to provide the seat rotating assembly 53 based on the previous embodiment, i.e., to rotatably connect the seat rotating assembly 53 with the seat moving assembly 52, specifically to rotatably connect the seat rotating assembly 53 with the mounting seat 521. The seat assembly 1 is fixed on the seat rotating assembly 53, allowing the seat assembly 1 to have both movement and rotation functions. When the seat rotating assembly 53 is directly rotatably connected to the top end of the folding mechanism 4, the seat rotating assembly 53 drives the seat assembly 1 to rotate 90° to the left or right compared to when the seat assembly 1 is facing forward. This can facilitate the user sitting on or leaving the seat assembly 1. After the user leaves the seat assembly 1, the entire adjustable seat structure can be folded without turning the seat assembly 1 back to the forward-facing position (refer to FIG. 4). Specifically, the folding mechanism 4 is switched to the folded position, the armrest elevating assembly 32 is lowered, and the armrest elevating assembly 32 is moved along the armrest moving assembly 34 to shorten the distance between the two armrest assemblies 31. Then, the armrest elevating assembly 32 is rotated about the axis of the armrest rotating assembly 33. At this time, the rotated armrest elevating assembly 32 is nearly parallel to the width direction of the seat assembly 1. The advantage of this approach is that since the front space of vehicle body of the scooter is relatively large and the space in the width direction is relatively open, it can effectively prevent interference between the armrest assembly 31 and components on the scooter when the armrest elevating assembly 32 drives the armrest assembly 31 to rotate. When the seat rotating assembly 53 is arranged by rotatably connecting it with the seat moving assembly 52, the seat rotating assembly 53 drives the seat assembly 1 to rotate 90° to the left or right compared to when the seat assembly 1 is facing forward. This can facilitate the user sitting on or leaving the seat assembly 1. After the user leaves the seat assembly 1, the entire adjustable seat structure can be folded without turning the seat assembly 1 back to the forward-facing position. Specifically, the folding mechanism 4 is switched to the folded position, the armrest elevating assembly 32 is lowered, and the armrest elevating assembly 32 is moved along the armrest moving assembly 34 to shorten the distance between the two armrest assemblies 31. Then, the armrest elevating assembly 32 is rotated about the axis of the armrest rotating assembly 33. At this time, the rotated armrest elevating assembly 32 is nearly parallel to the width direction of the seat assembly 1. Finally, according to the specific position of the folded armrest mechanism 3, the position of the seat moving assembly 52 on the base 51 is adjusted. The advantages of this method are that since the front space of vehicle body of the scooter is relatively large and the space in the width direction is relatively open, it can effectively prevent interference between the armrest assembly 31 and components on the scooter when the armrest elevating assembly 32 drives the armrest assembly 31 to rotate. Moreover, due to the arrangement of the base 51 and the seat moving assembly 52, the folding seat structure can be adjusted more flexibly, further improving space utilization and making the use of space more reasonable. It can be understood that the specific folding steps can be performed according to the actual situation and are not limited to the above steps. The sequence for adjusting each part can be reversed and changed.

In an embodiment, the seat rotating assembly 53 includes a turntable 531, an elastic member 532 and a rotation adjusting part 533 connected to the elastic member 532. The elastic member 532 is fixedly connected to a lower surface of the turntable 531, and the rotation adjusting part 533 is configured to position the elastic member 532 on a path rotating about a rotating shaft of the turntable 531. The rotation adjusting part 533 has a locked state and an unlocked state. When the rotation adjusting part 533 is in the locked state, the elastic member 532 is engaged with and limited by the rotation adjusting part 533. When an external force is applied to the rotation adjusting part 533, the rotation adjusting part 533 switches to the unlocked state, such that the turntable 531 and the elastic member 532 can rotate freely and synchronously.

In this embodiment, when the seat rotating assembly 53 is directly rotatably connected to the top end of the folding mechanism 4 (not shown in the figure), the rotation adjusting part 533 includes a bearing seat fixed to the top end of the folding mechanism 4. The bearing seat is provided with a first positioning hole. The elastic member 532 includes a fixed end fixedly connected to the turntable 531 and capable of rotating along with the turntable 531, and a free end attached to the bearing seat. The rotation adjusting part 533 further includes a positioning portion 5331 arranged on a lower surface of the free end and a hand-held portion 5332 fixedly connected to the free end. A lower surface of the seat assembly 1, the armrest moving assembly 34 and an upper surface of the turntable 531 are fixedly connected. When the rotation adjusting part 533 is in the locked state, the positioning portion 5331 engages with the first positioning hole. When an external force is applied to the hand-held portion 5332, driving the elastic member 532 to elastically deform, the positioning portion 5331 separates from the first positioning hole, and the rotation adjusting part 533 switches to the unlocked state. At least three first positioning holes are provided on the bearing seat. These three first positioning holes are located on the same circumference and are arranged at intervals of 90°, ensuring that the seat assembly 1 can be positioned at least at three positions on the path rotating about the rotating shaft of the turntable 531. That is, the seat assembly 1 can face at least three different directions. When the seat rotating assembly 53 is arranged by rotatably connecting it with the seat moving assembly 52, the elastic member 532 includes a fixed end fixedly connected to the turntable 531 and capable of rotating along with the turntable 531, and a free end attached to the mounting seat 521. The rotation adjusting part 533 includes a second positioning hole 5212 provided in the mounting seat 521, a positioning portion 5331 arranged on a lower surface of the free end, and a hand-held portion 5332 fixedly connected to the free end. The lower surface of the seat assembly 1, the armrest moving assembly 34 and the upper surface of the turntable 531 are fixedly connected. When the rotation adjusting part 533 is in the locked state, the positioning portion 5331 engages with the second positioning hole 5212. When an external force is applied to the hand-held portion 5332, driving the elastic member 532 to elastically deform, the positioning portion 5331 separates from the second positioning hole 5212, and the rotation adjusting part 533 switches to the unlocked state. The mounting seat 521 is provided with at least three second positioning holes 5212. These three second positioning holes 5212 are located on the same circumference and are arranged at intervals of 90°, ensuring that the seat assembly 1 can be positioned at least at three positions on the path rotating about the rotating shaft of the turntable 531. That is, the seat assembly 1 can face at least three different directions.

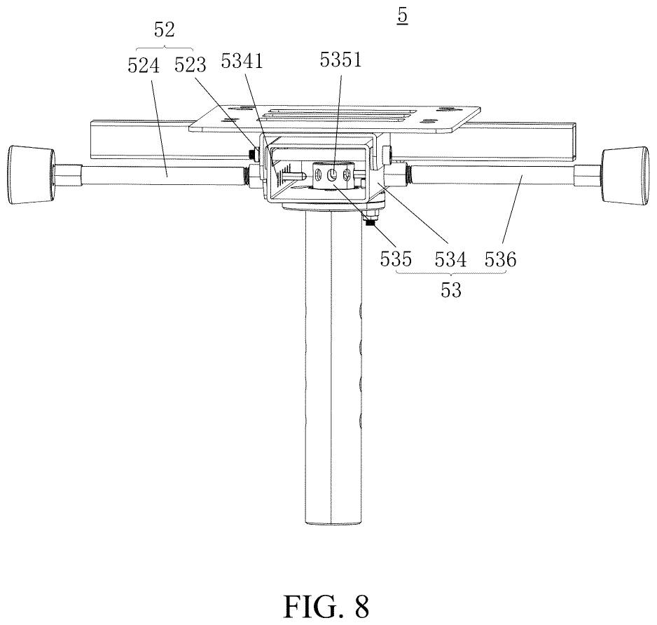

Referring to FIG. 8, in other embodiments, the seat moving assembly 52 includes a first seat support 523. The seat rotating assembly 53 includes a second seat support 534 and a limiting assembly 535. The first seat support 523 and the second seat support 534 are slidably connected, and the first seat support 523 can slide along a length direction of the second seat support 534. The second seat support 534 is rotatably connected to the limiting assembly 535, and the second seat support 534 can rotate about an axis of the limiting assembly 535. The second seat support 534 is provided with a plurality of first limiting holes 5341. The plurality of limiting holes are spaced apart along the length direction of the second seat support 534. A first locking assembly 524 is disposed through the first seat support 523 and can be engaged with the first limiting holes 5341 on the second seat support 534, thereby enabling the relative position between the first seat support 523 and the second seat support 534 to be locked or unlocked. The limiting assembly 535 is specifically a pipe fitting. A plurality of second limiting holes 5351 are provided in a circumferential direction of the limiting assembly 535. A second locking assembly 536 is disposed through the second seat support 534 and can be engaged with the second limiting holes 5351 on the limiting assembly 535 in the second seat support 534, thereby enabling the relative position between the second seat support 534 and the limiting assembly 535 to be locked or unlocked. Here, the second seat support 534 functions as the base 51.

In an embodiment, the armrest rotating assembly 33 includes a rotating shaft part 331 and a rotation control part 332. One end of the armrest elevating assembly 32 away from the armrest assembly 31 is sleeved on the rotating shaft part 331, and the armrest elevating assembly 32 can rotate about an axis of the rotating shaft part 331. The rotating shaft part 331 and the armrest elevating assembly 32 are connected via the rotation control part 332. The rotation control part 332 has an initial position and a terminal position in a length direction of the rotating shaft part 331. When the rotation control part 332 is at the terminal position, the armrest elevating assembly 32 can rotate freely about the rotating shaft part 331. When the armrest elevating assembly 32 rotates to a specific position, the rotation control part 332 rebounds from the terminal position to the initial position to restrict rotation of the armrest elevating assembly 32.

In this embodiment, one end of the armrest elevating assembly 32 connected to the rotating shaft part 331 is defined as a rotating end. A shaft hole is provided in the rotating end. The hole wall of the shaft hole is provided with two bearing portions 3221 and an accommodating groove 3222 for accommodating the rotation control part 332. The two bearing portions 3221 are respectively located on two sides of the accommodating groove 3222. The rotation control part 332 can move within the accommodating groove 3222 along an axial direction of the rotating end. One end of the rotating shaft part 331 connected to the armrest elevating assembly 32 is defined as a connecting end. A guide portion 3311 protrudes from an outer periphery of the connecting end. The guide portion 3311 abuts against the bearing portions 3221. When the armrest elevating assembly 32 rotates, the two bearing portions 3221 and the accommodating groove 3222 together form a guiding track through which the guide portion 3311 can pass. The rotation control part 332 includes a limiting portion. The limiting portion is connected to a groove bottom of the accommodating groove 3222 via an elastic component. When the elastic component is in a free state, the rotation control part 332 is at the initial position, and the limiting portion and the guide portion 3311 are located in the same plane to restrict rotation of the armrest elevating assembly 32. When the elastic component is in a compressed state, the rotation control part 332 is at the terminal position, and the limiting portion is flush with the two bearing portions 3221 to form the guiding track. A stop portion 3223 is formed between the two bearing portions 3221 along the hole wall of the shaft hole. The stop portion 3223 is located on a side away from the accommodating groove 3222. When the armrest elevating assembly 32 rotates to coincide with the bearing portions 3221 and avoid the accommodating groove 3222, the rotation control part 332 rebounds from the terminal position to the initial position, and the guide portion 3311 is limited between the limiting portion and the stop portion 3223. It can be understood that when the rotation control part 332 is pressed in a depth direction of the accommodating groove 3222 until the rotation control part 332 no longer blocks the rotating shaft part 331, i.e., it no longer restricts the relative rotation of the armrest elevating assembly 32 and the rotating shaft part 331 in the circumferential direction of the rotating shaft part 331, the relative limitation between the armrest elevating assembly 32 and the rotating shaft part 331 is unlocked, allowing the armrest elevating assembly 32 to rotate about the rotating shaft part 331 and drive the armrest assembly 31 to flip in a direction on the scooter that avoids the boarding/alighting position. During the rotation of the armrest elevating assembly 32 about the rotating shaft part 331, the rotation control part 332 is always pressed by the guide portion 3311 on the rotating shaft part 331. The position of the guide portion 3311 relative to the rotating end can move from one bearing portion 3221, over the top of the rotation control part 332, to the other bearing portion 3221. When the armrest elevating assembly 32 rotates to a specific position, i.e., when the armrest elevating assembly 32 rotates back to the original vertical position, the rotation control part 332 is no longer pressed by the guide portion 3311. Consequently, the rotation control part 332 rebounds to the initial position, re-limiting the armrest elevating assembly 32 and the rotating shaft part 331 to prevent relative rotation between them. The function of the stop portion 3223 is to limit the armrest elevating assembly 32 together with the rotation control part 332 in the initial position, preventing the armrest elevating assembly 32 from rotating relative to the rotating shaft part 331. By providing the rotation control part 332, folding and unfolding of the armrest elevating assembly 32 are facilitated, which is safer and more stable compared to a damping control structure.

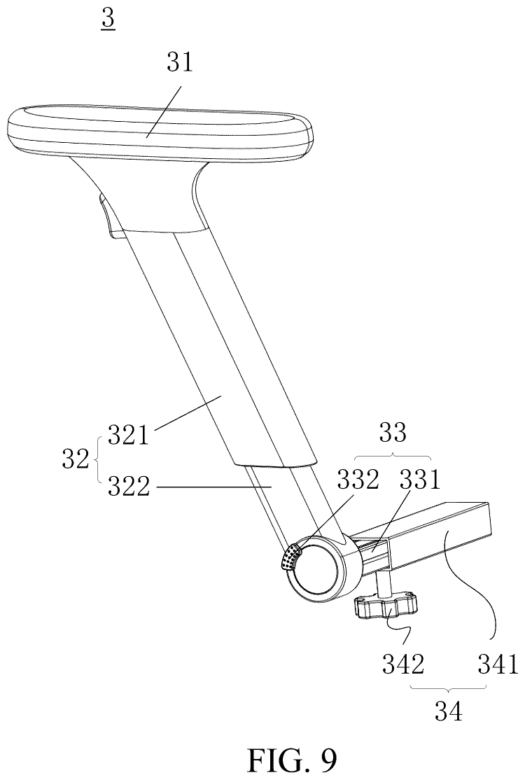

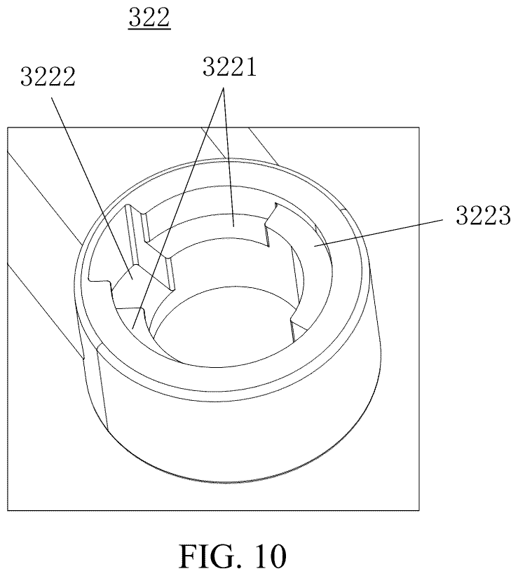

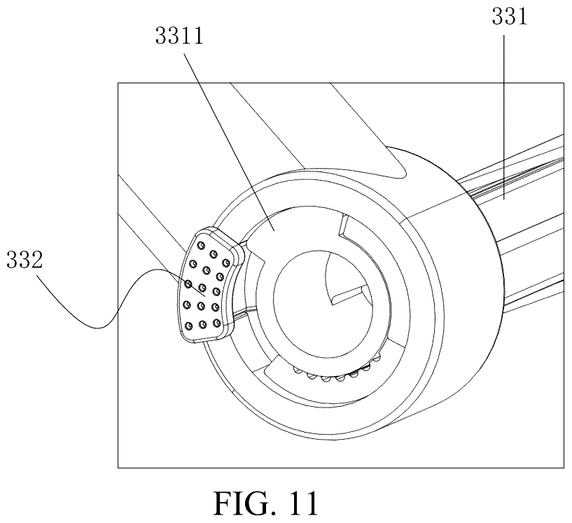

Referring to FIGS. 9 to 11, in an embodiment, the armrest elevating assembly 32 includes an elevating adjustment part 321 and a strut 322. The armrest assembly 31 is connected to the elevating adjustment part 321. The elevating adjustment part 321 is sleeved on the strut 322 to drive the armrest assembly 31 to move along a length direction of the strut 322. The armrest moving assembly 34 includes a hollow sleeve 341 fixed to the lower surface of the seat assembly 1. The armrest rotating assembly 33 is inserted into the hollow sleeve 341 to drive the two armrest assemblies 31 to move towards or away from each other along the width direction of the seat assembly 1.

In this embodiment, the strut 322 is connected to the rotating shaft part 331. The armrest elevating assembly 32 can be implemented in various forms, all of which are reflected in existing solutions, and thus will not be elaborated here. The armrest moving assembly 34 further includes a locking part 342 provided on the hollow sleeve 341. The rotating shaft part 331 is inserted into the hollow sleeve 341 and can move along the length direction of the hollow sleeve 341. The locking part 342 is configured to restrict the movement of the rotating shaft part 331 in the length direction of the hollow sleeve 341. The locking part 342 can specifically be a latch, a pull rod, or a fastener, etc., provided that it can lock the rotating shaft part 331 to prevent its movement relative to the hollow sleeve 341 and can unlock the rotating shaft part 331 to allow its movement relative to the hollow sleeve 341. The armrest mechanism 3 integrates the elevating function and the moving function. When the user is not using the vehicle, the height of the armrest assembly 31 can be lowered and the distance between the two armrest assemblies 31 can be reduced towards the interior of the scooter, thereby reducing the space occupied by the armrest mechanism 3.

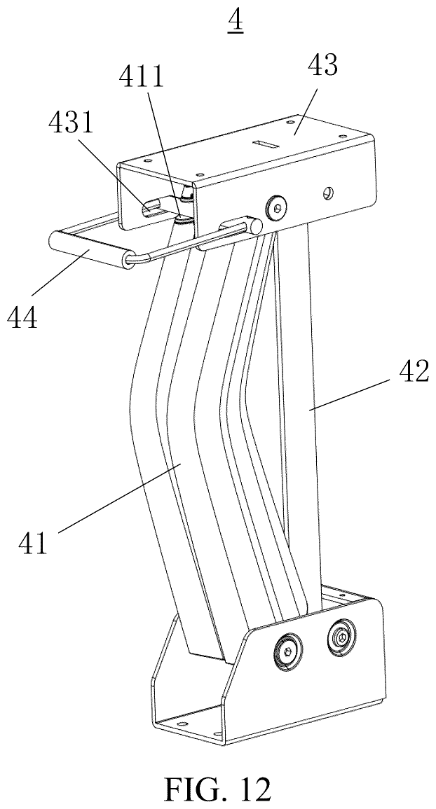

Referring to FIG. 12, in an embodiment, the folding mechanism 4 includes a front arm 41, a rear arm 42 and a seat bracket 43. The seat assembly 1 and the seat bracket 43 are fixedly connected. A top end of the front arm 41 is hinged to a front end of the seat bracket 43. A bottom end of the front arm 41 is hinged to the vehicle frame. A top end of the rear arm 42 is hinged to a rear end of the seat bracket 43. A bottom end of the rear arm 42 is hinged to the vehicle frame.

In this embodiment, the folding mechanism 4 is a four-bar mechanism. Damping control structures be simultaneously provided at all of the following connections, namely the connection between the top end of the front arm 41 and the seat bracket 43, the connection between the top end of the rear arm 42 and the seat bracket 43, the connection between the bottom end of the front arm 41 and the vehicle frame, and the connection between the bottom end of the rear arm 42 and the vehicle frame, to lock the front arm 41 and the rear arm 42, after rotating about the vehicle frame, at specific positions. It should be noted that when selecting damping control structures, the damping control structures need to be designed based on ensuring the stability and safety of the seat assembly 1 during normal use by the user, such that the folding mechanism 4 can be folded and unfolded. Alternatively, the front arm 41 and the rear arm 42 are locked by providing a mechanical control structure. When providing a mechanical control structure, specific mechanical structures are designed to limit or adjust the rotational position. Common mechanical structure control methods include, but are not limited to, key connections, pin connections, or threaded connections.

Furthermore, in an embodiment, the folding mechanism 4 further includes a sliding component 44. The seat bracket 43 is provided with a sliding chute 431. The sliding component 44 is slidably connected to the sliding chute 431. The front arm 41 is provided with a groove 411. When the sliding component 44 slides into the groove 411 along the sliding chute 431, the seat bracket 43, the front arm 41 and the rear arm 42 are fixed.

In this embodiment, when the seat assembly 1 needs to be unfolded, the seat bracket 43 is lifted until the sliding chute 431 aligns with the groove 411 of the front arm 41. At this time, the sliding component 44 slides into the groove 411 of the front arm 41 to fix the seat bracket 43, the front arm 41 and the rear arm 42. Subsequently, when the seat assembly 1 needs to be folded, the sliding component 44 is moved away from the groove 411 of the front arm 41 to achieve unlocking, and then the seat bracket 43 can be lowered. Through the design of the folding mechanism 4, the volume can be significantly reduced when the folding seat structure is not in use, facilitating the user to easily carry the scooter onto public transportation facilities, manually carry it over short distances, or store it in limited spaces, thereby improving portability, optimizing storage space, and enhancing transportation convenience.

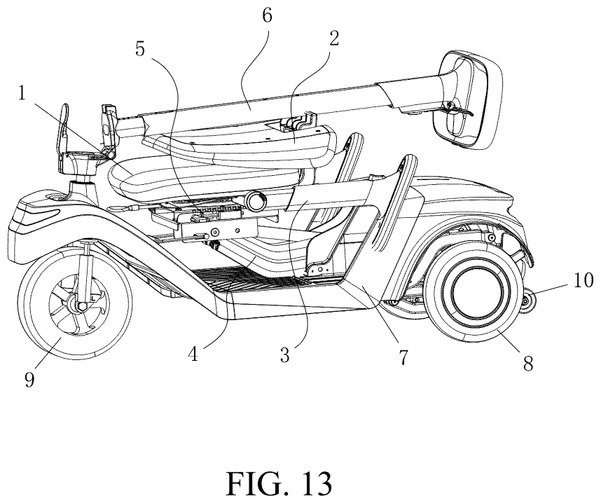

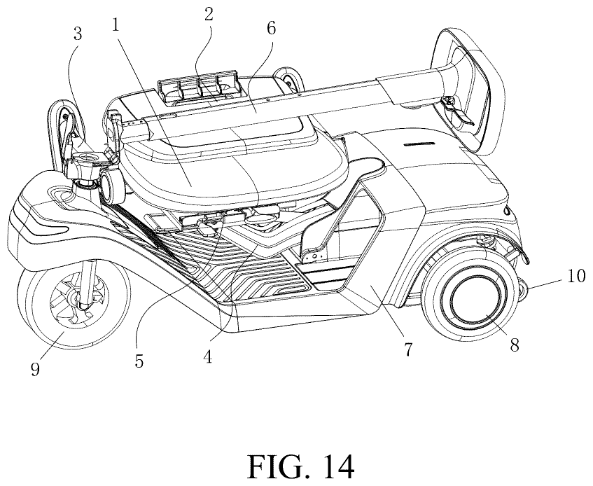

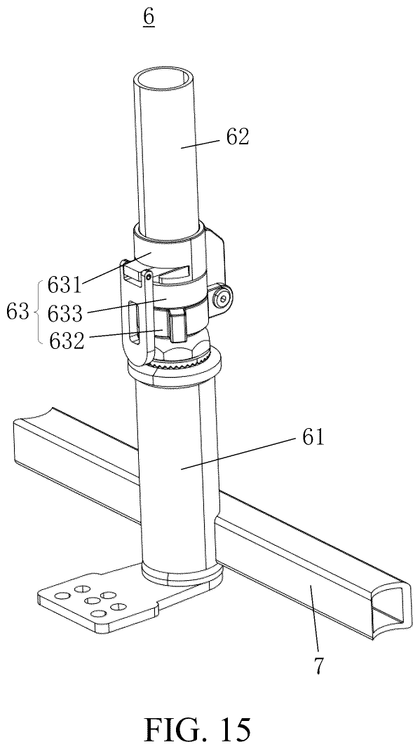

Referring to FIGS. 13 to 15, the present disclosure further provides a folding scooter, including a vehicle frame 7, a driving wheel set 8, a steering wheel set 9 and an auxiliary moving wheel set 10, and further including a handlebar mechanism 6 and the folding seat structure described in any one of the foregoing embodiments. The handlebar mechanism 6 includes a connecting component 61 fixed at a front end of the vehicle frame 7 and a handlebar component 62 rotatably connected to the connecting component 61. When the entire folding seat structure is in a folded state, the handlebar component 62 is folded over the folding seat structure relative to the connecting component 61.

In this embodiment, the driving wheel set 8 is usually the rear wheel of the folding scooter, and the steering wheel set 9 is usually the front wheel of the folding scooter. The number of wheels in the steering wheel set 9 can be one or two. In the embodiments shown in the present disclosure, the case where the number of wheels in the steering wheel set 9 is one is taken as an example. The auxiliary moving wheel set 10 is usually arranged near the ground at the rear end of the folding scooter. During normal operation of the folding scooter, a certain distance is maintained between the auxiliary moving wheel set 10 and the ground, and it does not affect the driving of the scooter. When the folding scooter is folded, the auxiliary moving wheel set 10 can enhance the mobility and portability of the folding scooter. Specifically, the folding scooter is designed to reduce its volume when not in use, facilitating transportation and storage. The auxiliary moving wheel set 10 remains attached to the folding scooter and connected to the vehicle frame 7 even after folding, allowing the entire structure to be easily moved even in the folded state without requiring additional manual handling. The auxiliary moving wheel set 10 can be specifically designed as a retractable structure with adjustable track width. This adjustability allows the auxiliary moving wheel set 10 to adjust its distance from the ground and the track width as needed to ensure structural stability and mobility. The handlebar mechanism 6 can be implemented in various forms, all of which are reflected in existing solutions, and thus will not be elaborated here, provided that it can be rotated and folded relative to the vehicle frame 7. The folding seat structure and folding scooter described in this disclosure are designed primarily for use by the elderly and people with disabilities. Since the folding scooter of the present disclosure is provided with the folding seat structure, which is designed with the backrest mechanism 2, the armrest mechanism 3 and the folding mechanism 4, the backrest mechanism 2 can be stowed towards the seat assembly 1 after use, being folded into a relatively flat shape. The folding mechanism 4 can lower and stow the overall structure of the seat, enabling the folding scooter to be significantly reduced in size when not in use, facilitating easy carrying, transporting and storage by the user. Moreover, the folding mechanism 4 is arranged at the central position in the width direction of the vehicle frame 7, making the folding and unfolding of the entire seat smoother, while reducing the occupation of space on both sides of the folding scooter and eliminating restrictions on the activity space of the user. In addition, the armrest mechanism 3 integrates the elevating function, rotating function and moving function. When the user is not using the folding scooter, not only can the height of the armrest assembly 31 be lowered and the distance between the two armrest assemblies 31 be reduced towards the interior of the folding scooter to decrease the space occupied by the armrest mechanism 3, but the armrest rotating assembly 33 can also be combined to drive the armrest assembly 31 to rotate, allowing it to be stowed into a smaller size.

Further, in an embodiment, the handlebar mechanism 6 further includes a folding assembly 63. The folding assembly 63 includes a first folding piece 631 connected to the connecting component 61 and a second folding piece 632 connected to the handlebar component 62. The first folding piece 631 and the second folding piece 632 are rotatably connected. A locking piece 633 is arranged between the first folding piece 631 and the second folding piece 632. The locking piece 633 is coaxially arranged with the first folding piece 631 and can rotate relative to the first folding piece 631 about a common axis.

In this embodiment, the locking piece 633 has a first position and a second position. When the locking piece 633 is in the first position, the locking piece 633 locks the second folding piece 632, restricting relative rotation of the second folding piece 632 relative to the first folding piece 631. When the locking piece 633 is in the second position, the locking piece 633 avoids the second folding piece 632, releasing the limitation between the second folding piece 632 and the first folding piece 631. The first folding piece 631 and the second folding piece 632 are rotatably connected, allowing the second folding piece 632 to rotate relative to the first folding piece 631 about a rotating shaft. The second folding piece 632 is fixedly connected to the handlebar component 62, so the handlebar component 62 can be folded along with the second folding piece 632 in a direction towards the connecting component 61. The folding assembly 63 has an upright state and a folded state. When the folding assembly 63 is in the upright state, the first folding piece 631 and the second folding piece 632 are coaxially arranged. When the folding assembly 63 is in the folded state, the second folding piece 632 and the first folding piece 631 are folded together, and the axis of the first folding piece 631 is parallel to the axis of the second folding piece 632. The locking piece 633 is configured to lock the second folding piece 632 when the folding assembly 63 is in the upright state, keeping the handlebar mechanism 6 in a stable working state. Since the locking piece 633 is coaxially arranged with the first folding piece 631 and can only rotate about the common axis relative to the first folding piece 631, when the locking piece 633 rotates to the first position, it can engage the second folding piece 632 at a position coaxial with the first folding piece 631, preventing the second folding piece 632 from folding around the first folding piece 631 towards the direction of the connecting component 61. When the locking piece 633 rotates to the second position, the restriction on the second folding piece 632 is released, and the second folding piece 632 can freely rotate about the first folding piece 631. Since the folding scooter has the handlebar mechanism 6 which includes the folding assembly 63, when the locking piece 633 in the folding assembly 63 rotates to the first position about the axis of the first folding piece 631, it can lock the first folding piece 631 and the second folding piece 632 together. When folding is required, the locking piece 633 is simply rotated to the second position to release the limitation on the second folding piece 632. This arrangement offers a simple structure, convenient operation, small footprint, light weight, and an enhanced user experience.

It should be understood that various forms of flows shown above can be used, and steps can be reordered, added, or deleted. For example, the steps described in the present disclosure can be performed in parallel, sequentially, or in a different order, provided that the desired results of the technical solution disclosed in the present disclosure can be achieved, and it is not limited herein.

Furthermore, the terms “first” and “second” are used for descriptive purposes only and cannot be construed as indicating or implying relative importance or implicitly indicating the number of the referred technical features. Thus, features defined by “first” and “second” can explicitly or implicitly include one or more such features. In the description of this disclosure, “multiple” means two or more, unless otherwise expressly and specifically defined.

The above are only specific implementations of the present disclosure, but the scope of protection of the present disclosure is not limited thereto. Any variation or substitution readily conceivable by those skilled in the art within the technical scope disclosed herein shall fall within the scope of protection of the present disclosure. Therefore, the scope of protection of the present disclosure shall be determined by the scope of protection of the appended claims.

What is claimed is:

1. A folding seat structure, comprising a seat assembly, wherein the folding seat structure further comprises:
a backrest mechanism, rotatably connected to the seat assembly and capable of being folded relative to the seat assembly;
an armrest mechanism, comprising an armrest assembly, an armrest elevating assembly, an armrest rotating assembly, and an armrest moving assembly, wherein the armrest moving assembly is fixedly connected to a lower surface of the seat assembly and is arranged along a width direction of the seat assembly; the armrest rotating assembly is slidably connected to the armrest moving assembly and is capable of sliding along a length direction of the armrest moving assembly; one end of the armrest elevating assembly is rotatably connected to the armrest rotating assembly; and the armrest assembly is arranged on the other end of the armrest elevating assembly; and
a folding mechanism, wherein the seat assembly is arranged at a top end of the folding mechanism, and a bottom of the folding mechanism is hinged at a central position in a width direction of a vehicle frame and is capable of being switched between an unfolded position and a folded position relative to the vehicle frame.

2. The folding seat structure according to claim 1, further comprising a seat adjusting mechanism arranged between the seat assembly and the folding mechanism, wherein the seat adjusting mechanism comprises a base and a seat moving assembly connected to the seat assembly, the base is fixedly connected to the top end of the folding mechanism, and the seat moving assembly is slidably connected to the base.

3. The folding seat structure according to claim 1, further comprising a seat adjusting mechanism arranged between the seat assembly and the folding mechanism, wherein the seat adjusting mechanism comprises a seat rotating assembly for carrying the seat assembly, and the seat rotating assembly is rotatably connected to the folding mechanism to drive the seat assembly to rotate relative to the folding mechanism.

4. The folding seat structure according to claim 3, wherein the seat rotating assembly comprises a turntable, an elastic member and a rotation adjusting part connected to the elastic member, the elastic member is fixedly connected to a lower surface of the turntable, and the rotation adjusting part is configured to position the elastic member on a path rotating about a rotating shaft of the turntable; and
the rotation adjusting part has a locked state and an unlocked state; when the rotation adjusting part is in the locked state, the elastic member is engaged with and limited by the rotation adjusting part; and when an external force is applied to the rotation adjusting part, the rotation adjusting part is switched to the unlocked state, such that the turntable and the elastic member are capable of rotating synchronously and freely.

5. The folding seat structure according to claim 1, wherein the armrest rotating assembly comprises a rotating shaft part and a rotation control part, one end of the armrest elevating assembly away from the armrest assembly is sleeved on the rotating shaft part, and the armrest elevating assembly is capable of rotating about an axis of the rotating shaft part, and the rotating shaft part and the armrest elevating assembly are connected via the rotation control part; and
the rotation control part has an initial position and a terminal position in a length direction of the rotating shaft part; when the rotation control part is at the terminal position, the armrest elevating assembly is capable of rotating freely about the rotating shaft part; and when the armrest elevating assembly rotates to a specific position, the rotation control part rebounds from the terminal position to the initial position to restrict rotation of the armrest elevating assembly.

6. The folding seat structure according to claim 1, wherein the armrest elevating assembly comprises an elevating adjustment part and a strut, the armrest assembly is connected to the elevating adjustment part, and the elevating adjustment part is sleeved on the strut to drive the armrest assembly to move along a length direction of the strut; the armrest moving assembly comprises a hollow sleeve fixed on the lower surface of the seat assembly, and the armrest rotating assembly is inserted into the hollow sleeve to drive the two armrest assemblies to move towards or away from each other along the width direction of the seat assembly.

7. The folding seat structure according to claim 1, wherein the folding mechanism comprises a front arm, a rear arm and a seat bracket, the seat assembly and the seat bracket are fixedly connected, a top end of the front arm is hinged to a front end of the seat bracket, a bottom end of the front arm is hinged to the vehicle frame, a top end of the rear arm is hinged to a rear end of the seat bracket, and a bottom end of the rear arm is hinged to the vehicle frame.

8. The folding seat structure according to claim 7, wherein the folding mechanism further comprises a sliding component, the seat bracket is provided with a sliding chute, the sliding component is slidably connected to the sliding chute, the front arm is provided with a groove, and when the sliding component slides into the groove along the sliding chute, the seat bracket, the front arm and the rear arm are fixed.

9. The folding seat structure according to claim 2, further comprising a seat adjusting mechanism arranged between the seat assembly and the folding mechanism, wherein the seat adjusting mechanism comprises a seat rotating assembly for carrying the seat assembly, and the seat rotating assembly is rotatably connected to the folding mechanism to drive the seat assembly to rotate relative to the folding mechanism.

10. The folding seat structure according to claim 9, wherein the seat rotating assembly comprises a turntable, an elastic member and a rotation adjusting part connected to the elastic member, the elastic member is fixedly connected to a lower surface of the turntable, and the rotation adjusting part is configured to position the elastic member on a path rotating about a rotating shaft of the turntable; and
the rotation adjusting part has a locked state and an unlocked state; when the rotation adjusting part is in the locked state, the elastic member is engaged with and limited by the rotation adjusting part; and when an external force is applied to the rotation adjusting part, the rotation adjusting part is switched to the unlocked state, such that the turntable and the elastic member are capable of rotating synchronously and freely.

11. A folding scooter, comprising a vehicle frame, a driving wheel set, a steering wheel set and an auxiliary moving wheel set, wherein the folding scooter further comprises a handlebar mechanism and the folding seat structure according to claim 1, wherein the handlebar mechanism comprises a connecting component fixed at a front end of the vehicle frame and a handlebar component rotatably connected to the connecting component, and when the entire folding seat structure is in a folded state, the handlebar component is folded over the folding seat structure relative to the connecting component.

12. The folding scooter according to claim 11, wherein the handlebar mechanism further comprises a folding assembly, the folding assembly comprises a first folding piece connected to the connecting component and a second folding piece connected to the handlebar component, the first folding piece and the second folding piece are rotatably connected, a locking piece is arranged between the first folding piece and the second folding piece, and the locking piece is coaxially arranged with the first folding piece and is capable of rotating relative to the first folding piece about a common axis.

13. The folding scooter according to claim 11, wherein the folding seat structure further comprises a seat adjusting mechanism arranged between the seat assembly and the folding mechanism, wherein the seat adjusting mechanism comprises a base and a seat moving assembly connected to the seat assembly, the base is fixedly connected to the top end of the folding mechanism, and the seat moving assembly is slidably connected to the base.

14. The folding scooter according to claim 11, wherein the folding seat structure further comprises a seat adjusting mechanism arranged between the seat assembly and the folding mechanism, wherein the seat adjusting mechanism comprises a seat rotating assembly for carrying the seat assembly, and the seat rotating assembly is rotatably connected to the folding mechanism to drive the seat assembly to rotate relative to the folding mechanism.

15. The folding scooter according to claim 14, wherein the seat rotating assembly comprises a turntable, an elastic member and a rotation adjusting part connected to the elastic member, the elastic member is fixedly connected to a lower surface of the turntable, and the rotation adjusting part is configured to position the elastic member on a path rotating about a rotating shaft of the turntable; and
the rotation adjusting part has a locked state and an unlocked state; when the rotation adjusting part is in the locked state, the elastic member is engaged with and limited by the rotation adjusting part; and when an external force is applied to the rotation adjusting part, the rotation adjusting part is switched to the unlocked state, such that the turntable and the elastic member are capable of rotating synchronously and freely.

16. The folding scooter according to claim 11, wherein the armrest rotating assembly comprises a rotating shaft part and a rotation control part, one end of the armrest elevating assembly away from the armrest assembly is sleeved on the rotating shaft part, and the armrest elevating assembly is capable of rotating about an axis of the rotating shaft part, and the rotating shaft part and the armrest elevating assembly are connected via the rotation control part; and
the rotation control part has an initial position and a terminal position in a length direction of the rotating shaft part; when the rotation control part is at the terminal position, the armrest elevating assembly is capable of rotating freely about the rotating shaft part; and when the armrest elevating assembly rotates to a specific position, the rotation control part rebounds from the terminal position to the initial position to restrict rotation of the armrest elevating assembly.

17. The folding scooter according to claim 11, wherein the armrest elevating assembly comprises an elevating adjustment part and a strut, the armrest assembly is connected to the elevating adjustment part, and the elevating adjustment part is sleeved on the strut to drive the armrest assembly to move along a length direction of the strut; the armrest moving assembly comprises a hollow sleeve fixed on the lower surface of the seat assembly, and the armrest rotating assembly is inserted into the hollow sleeve to drive the two armrest assemblies to move towards or away from each other along the width direction of the seat assembly.

18. The folding scooter according to claim 11, wherein the folding mechanism comprises a front arm, a rear arm and a seat bracket, the seat assembly and the seat bracket are fixedly connected, a top end of the front arm is hinged to a front end of the seat bracket, a bottom end of the front arm is hinged to the vehicle frame, a top end of the rear arm is hinged to a rear end of the seat bracket, and a bottom end of the rear arm is hinged to the vehicle frame.

19. The folding scooter according to claim 18, wherein the folding mechanism further comprises a sliding component, the seat bracket is provided with a sliding chute, the sliding component is slidably connected to the sliding chute, the front arm is provided with a groove, and when the sliding component slides into the groove along the sliding chute, the seat bracket, the front arm and the rear arm are fixed.
